(19) United States
(12) Patent Application Publication
(10) Pub. No.: US 2008/0082424 A1
(43) Pub. Date: Apr. 3, 2008

(54) SYSTEM FOR OPTIMIZING PICKUP OF GOODS BY A PURCHASER FROM A VENDOR USING LOCATION-BASED ADVERTISING

(76) Inventor: Matthew Walton, Pearl City, HI (US)

Correspondence Address: LEIGHTON K. CHONG;PATENT ATTORNEY, 133 KAAI STREET, HONOLULU, HI, 96821, US

(21) Appl. No.: 11/537,512

(22) Filed: Sep. 29, 2006

(51) Int. Cl. G06Q 30/00

(52) U.S. Cl. 705/26

(57) ABSTRACT

A system for optimizing pickup of goods employs a server for tracking orders placed by purchasers with vendors for pick-up at delivery locations in a service area, a location-aware device operated by a purchaser for notifying the server of identity and location when a purchaser is ready to proceed in transit to a real or potential delivery location in the service area, and a messaging device for the purchaser to receive ads sent by the server during a delivery time window based on an estimated time-of-arrival of the purchaser to the real or potential delivery location. By sending location-based ads to the purchaser in transit, the purchaser can be notified of other purchasing options along the way and can place additional orders to be consolidated for pickup at the delivery location. Vendors can use the system to provide “just-in-time” direct advertising to customers, and customers are motivated to subscribe to the system for convenience of delivery and time saving while shopping.

### TECHNICAL FIELD

This invention generally relates to systems for using location-based or location-specific information, and in particular, to one for optimizing the pickup of goods by a purchaser from a vendor, along with the use of location-based advertising.

### BACKGROUND OF INVENTION

The number of cellular phones with advanced messaging technology is growing quickly as users are embracing the new communications technology. Cellular providers are offering new features at reduced prices even as wireless web infrastructure is growing. Text messaging, cellular instant messaging and SMS messaging are gaining in popularity. Many mobile devices have been outfitted with GPS transceivers that can transmit present location information automatically to other applications. Programs making use of location-specific information have increased efficiency in supply chains in many industries where asset tracking has been successful. Prohibitive cost, however, has prevented widespread use of such technology outside of industry. Costs of component parts of such programs have only recently declined sufficiently to allow users to profitably modify such systems for use in finding new markets for small businesses and individuals who want to increase productivity.

Knowing the exact present location of a user or the user's communication device is useful in a host of security, military, and commercial applications. One underdeveloped area of development and commercialization, however, is in utilizing present location information to extrapolate future locations and times of arrival at those locations. If applications can be developed which accurately predict an entity's future location and time of arrival, there is likely to be savings of cost or gains in productivity. The efficiencies created by simultaneous travel performed by the person picking up goods or materials, coupled with preparation for delivery performed by the vendor or provisioner, are potentially enormous. One need only consider the number of man-hours humans spend in transit to pickup goods or materials, only to arrive and begin waiting for their delivery.

There are numerous difficulties in accurately predicting an entity's future location and time of arrival based on their present location. Among the most complex difficulties is the fact that people are free to choose when, where, and at what rate they travel from one location to another. Also the unpredictability of traffic jams and other happenings may delay arrival at a future location beyond what is predicted. Public transportation, especially bus systems, is notoriously unable to keep schedules due to such unpredictability.

Much of the prior art in the field of location-based services and mobile commerce relates to location-sensitive communication devices for obtaining or using location-specific information. In short, many devices are built to show where a user is presently located rather than where a user will be in the future. Additionally, much prior art is focused on putting information and the power to transact in the hands of a mobile user, requiring difficult and unwieldy interaction with small, technically complex devices.

### SUMMARY OF INVENTION

To overcome the disadvantages of prior art location based systems, the present invention employs prediction of future time-of-arrival(s) to optimize efficiencies for a purchaser's travel to a pickup location and preparation of a vendor for fulfillment of a transaction by delivery of goods when the purchaser arrives. In conjunction with a predicted time of arrival (ETA) at a known future location or locations, the system enables the automatic formatting and sending of messages, including location-based advertising, to the purchaser in transit to the destination. Besides savings of cost and gains in productivity, the invention can provide ancillary benefits of new traffic management technologies, relieving traffic congestion, and increasing the ability of vendors to advertise and/or sell goods to a purchaser in transit.

The system has a central processing server that monitors whether a customer order is active for delivery and whether the customer is in transit for pickup. Monitoring may be initiated by a customer call from a cellphone, message from a mobile device, logging online with the system from the user's PC or location-based touch-screen kiosk, and/or by detection of a customer RFID tag by a location-aware device in the vicinity of the customer. The server next estimates the time of arrival (ETA) at the designated order pickup location. Within the ETA “delivery window”, the server checks its vendor database and can formulate ad messages to the customer of sales, discounts, or other products of vendors having stores located along the way to or in the vicinity of the designated order pickup point. These messages are transmitted to the customer through their preferred type of mobile device, such as a cellphone, or PDA email address, or other mobile device display.

Vendors are motivated to utilize the system to provide “just-in-time” direct advertising to customers in purchasing mode. Users are motivated to subscribe to the system because it is a more convenient and time saving means of shopping. Additionally, vendors can save money by utilizing their delivery procedures more efficiently.

### BRIEF DESCRIPTION OF DRAWINGS

FIG. 1 shows a schematic overview of the present invention in which a central processing server operates between a vendor's PC, a User's PC, and location-aware devices for identifying users in a locale.

FIG. 2 shows an example of various location-aware devices by which users can make known their locations in real time to the central processing server.

FIG. 3 shows an example of communications identifying users from location-aware devices and vendor communications to the central processing server.

FIG. 4 shows an example of a formatted message sent to vendors when a customer is in transit to pick up order in the system at a pickup location.

FIG. 5 shows the time-based sequence of events for an active order logged in the system.

FIG. 6 shows a typical flow of vendor interactions with the system.

FIG. 7 shows a typical flow of user interactions with the system.

FIG. 8 illustrates the flow of the user's ordering process in the system.

### DETAILED DESCRIPTION OF INVENTION

In the following detailed description, certain preferred embodiments are described as illustrations of the invention in a specific application, network, or computer environment in order to provide a thorough understanding of the present invention. Those methods, procedures, components, or functions which are commonly known to persons of ordinary skill in the field of the invention are not described in detail as not to unnecessarily obscure a concise description of the present invention. Certain specific embodiments or examples are given for purposes of illustration only, and it will be recognized by one skilled in the art that the present invention may be practiced in other analogous applications or environments and/or with other analogous or equivalent variations of the illustrative embodiments.

Some portions of the detailed description which follows are presented in terms of procedures, steps, logic blocks, processing, and other symbolic representations of operations on data bits within a computer memory. These descriptions and representations are the means used by those skilled in the data processing arts to most effectively convey the substance of their work to others skilled in the art. A procedure, computer executed step, logic block, process, etc., is here, and generally, conceived to be a self-consistent sequence of steps or instructions leading to a desired result. The steps are those requiring physical manipulations of physical quantities. Usually, though not necessarily, these quantities take the form of electrical or magnetic signals capable of being stored, transferred, combined, compared, and otherwise manipulated in a computer system. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the following discussions, it is appreciated that throughout the present invention, discussions utilizing terms such as “processing” or “computing” or “translating” or “calculating” or “determining” or “displaying” or “recognizing” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Aspects of the present invention, described below, are discussed in terms of steps executed on a computer system, which may be one of any type having suitable computing resources. Aspects of the present invention are also discussed with respect to an Internet system including electronic devices and servers coupled together within the Internet platform, but it may be similarly implemented on any other type of extended network system including wireless data or digital phone networks. A computer system can also include a communication device for interfacing with other networks or sending messages over the Internet or wireless communications systems. The system may be implemented using PC or client computers coupled to a wired network, or using mobile devices connected to a mobile or wireless network.

It is also noted that the present preferred embodiment contains references to technologies presently available in the marketplace. The invention in its essence, however, is not in anyway tied to any particular technology, but rather only requires that any present or future method deliver key data elements in a way that is consistent.

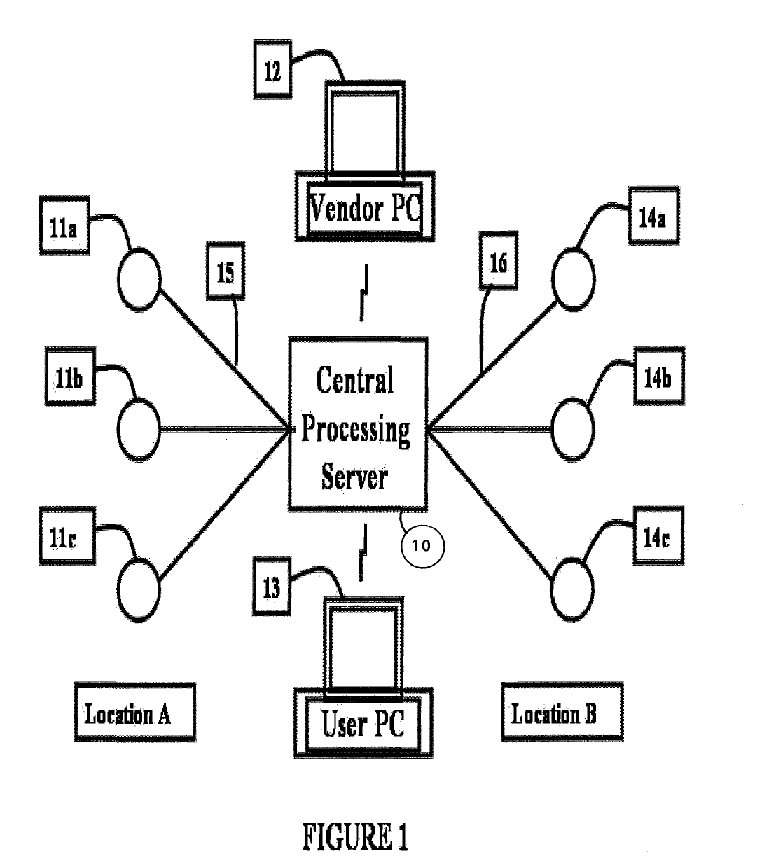

Referring to FIG. 1, a central processing server 10 operates between a Vendor PC 12, a User PC 13, location-aware devices 11a, 11b, 11c, etc., in the possession of users, and message-receiving devices 14a, 14b, 14c, etc., in possession of vendors or delivery agents to track deliveries to users. Users can initiate the process for pickup of an active order through the devices 11, such as by a customer call from a cellphone, message from a mobile device, logging online with the system from the user's PC or location-based device such as a touch-screen kiosk, and/or by detection of a customer RFID tag by a location-aware device in the vicinity of the customer. Based on receipt of the customer's identity and location information 15 sent by the devices 11, the server 10 can then calculate the customer's time of arrival (ETA) to the designated order pickup location. Within the ETA “delivery window”, the server checks its vendor database and can formulate ad messages to the customer of sales, discounts, or other products of vendors having stores located along the way to or in the vicinity of the designated order pickup point.

The terms “vendor”, “agent”, and “delivery agent” may be used interchangeably with regard to the entity or entities communicated to by the system for the process of making delivery and/or coordinating delivery of multiple purchases to a purchaser. An “agent” more specifically may be an employee or third-party contractor that coordinates the delivery of purchased goods from one or more vendors to a purchaser.

The customer identity and location information 15 may be a data file, a direct file update, email, or various other means of updating database tables on the server 10. The incoming data elements to the server 10 immediately receive a time stamp as to the exact time the location and identity information are received. Variations of devices 11 may deliver more information to server 10, such as is the case with cellular telephone and kiosk devices that deliver product and service order information in addition to the required identity and location data.

Devices 11 may also be location-aware devices that can detect the physical location of customers at locations in the service area of the server's operations. For example, these devices may be Radio Frequency Identification (RFID) readers that are placed in stores, malls, parking lots, or near major roadways so that any device may ascertain the location of customers in its vicinity. Each device is coupled to a data transmitter or a computer with connectivity to the server. When the customer carrying or wearing an ID-encoded RFID tag comes within range of the RFID reader, an ID signal is sent to the field transmitter or computer, which then sends a message logging the location and identity of the detected ID tag to the central processing server 10 for entering in the system database as a time-stamped record.

The RFID readers may be placed in locales where significant traffic occurs and therefore are most productive. The most effective placement of RFID readers would be on a pedestrian passageway or road with a variety of shopping alternatives along the way or near its intersections or exits. In this way each reader may serve many customers. RFID reader comes in a variety of read ranges. It is therefore important to choose the correct reader for the implementation. The placement of RFID reader is critical as well because it determines the traveler's mode of transport. For example a reader located along highway would assume that a customer is traveling via automobile, while a reader located in an elevator would assume that the customers are traveling via foot.

Alternative location-aware devices to RFIDs readers include public phone devices, videocam monitors, public kiosks, and other publicly installed, identifying devices. Similarly as above, the type and placement of location-aware device can be used to determine a traveler's mode of travel. Monitors located in buildings assume travelers are on foot, while those in parking lots will assume transportation by automobiles. Telephone-based GPS technology is becoming more widely used and is likely to be a cheaper alternative to establishing location of a user in the future. In this case, a GPS cellular phone would serve as the conduit of information to the main server data base.

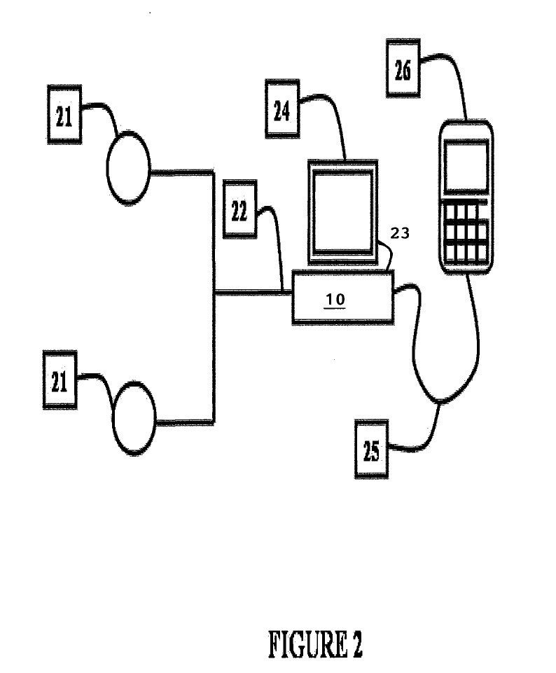

FIG. 2 shows an example of various location-aware devices by which users can make known their locations in real time to the central processing server. RFID detector devices 22 placed in the vicinity of pedestrian passageways, malls, roads, etc., can send their detection signals 22 to the server 10. Similarly, a PC computer or public kiosk 24 placed in a commercial location for access by a user can be used to send an identifying message 23, or a user's cellphone 26 can be used to place a call 25 that identifies user and location (such as by a voice message, or automatically through device ID and GPS location signaling) for logging on the server 10.

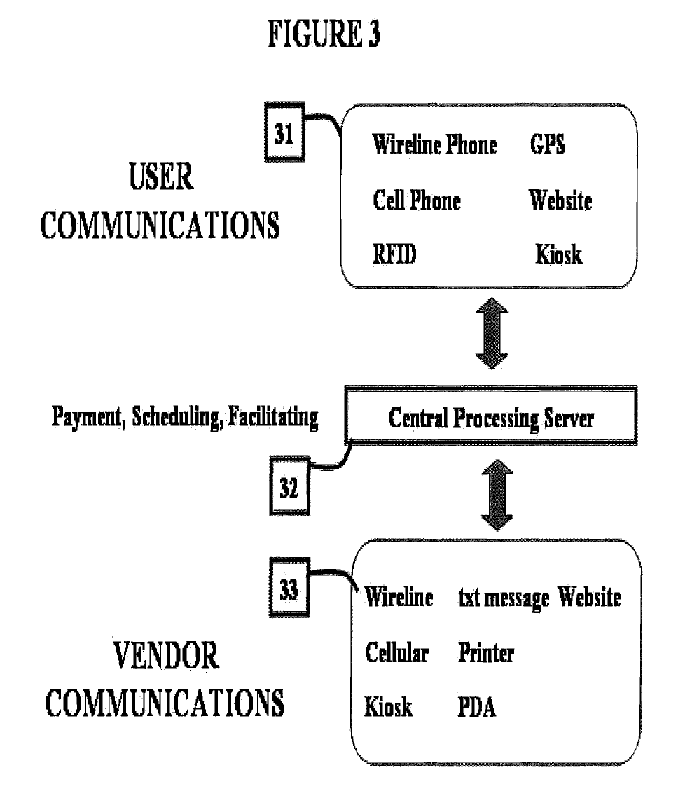

FIG. 3 shows an example of communications 31 identifying users from location-aware devices and vendor communications 33 from vendor PCs or agent messaging devices to the central processing server. The server may also perform related administrative functions 32, such as tracking payment, scheduling deliveries, facilitating ad placements, etc.

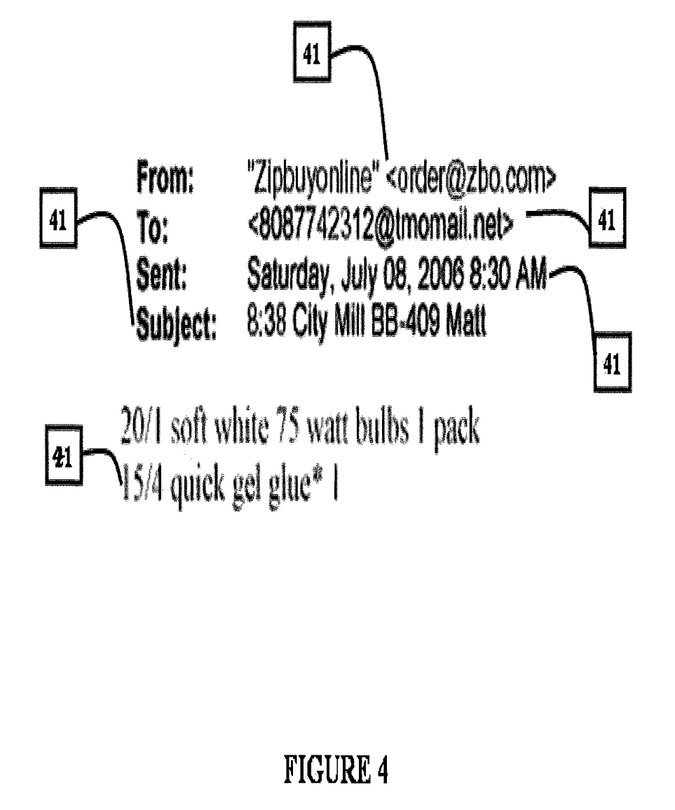

FIG. 4 shows an example of a formatted message sent to vendors when a customer is in transit to pick up order in the system at a pickup location. Fields 41 denote important data items. In this example, the customer's location message was sent at 8:30 am, and the server has calculated an estimated time of arrival in 8 minutes, i.e., “8:38” in the “Subject” line. The delivery location in this case is “City Mill”, which is assumed to be the parking lot in front of the City Mill store. The customer's license plate number, BB-409, has been given to identify the customer to delivery personnel. The body of the message identifies the products to be delivered, and may even include the aisle/sector (denoted by numbers separated by “/”) in inventory where the item may be found. The message may include other data, such as whether the agent has a coupon available for the item.

Once server 10 receives and timestamps the user location and identity records, it proceeds through a multi-step process to evaluate the information for a match of user identity with orders for products and services stored in the database under that identity. In a preferred embodiment, a message may be sent telephonically, via text message, or via email back to the user's device to verify a pending order, but this is not required and may be set by user preference. Updates of user locations which cannot be matched with product or service orders may be deleted so as to protect user privacy.

Orders for products and services to be picked up from vendors in the server's service area are entered in the server's database from a vendor PC 12, such as when a customer places an order with a teller or cashier while shopping in a store, or from a user PC 13 such as when a usr is shopping online. Telephone orders can also be captured in a similar manner by automated telephone-based order recognition systems, or even by manual input of telephone operators into the server's database. Orders may also be forwarded from online vendor websites or from distribution intermediaries or order consolidators. Users, vendors, distribution intermediaries and order consolidators are expected to be motivated to place orders to be delivered in the service area on the server's database because of the advantages for cost savings, productivity gains, advertising, and cross marketing the system is expected to provide, as described in further detail below.

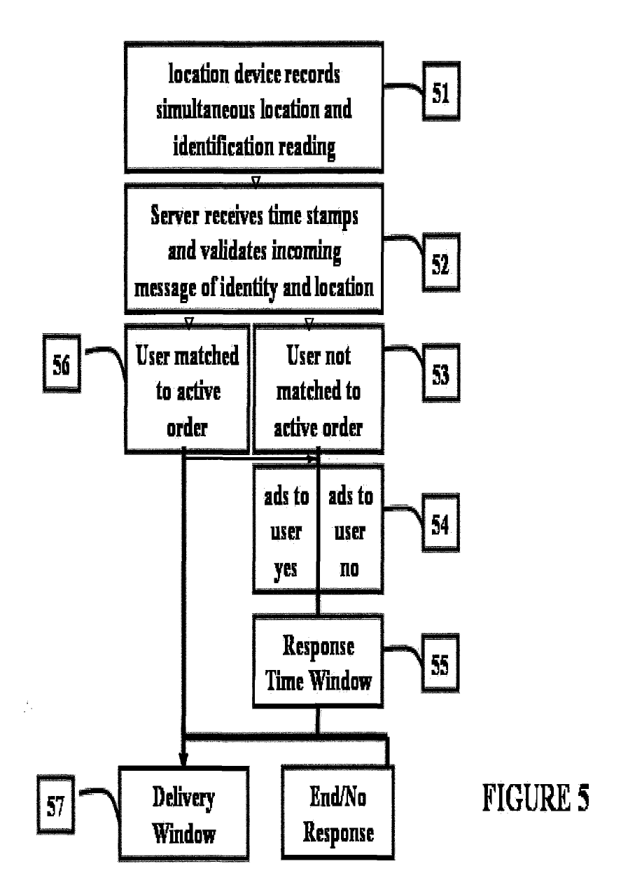

Referring to FIG. 5, for an active order logged in the system, the server 10 monitors at block 51 whether the customer for the order is detected to be in the vicinity of any of its universe of location-aware devices, and if detected the detection entry is timestamped and validated for the customer's identity and location at block 52. Detection may be by RFID devices if customers are provided with RFID tags, such as one embedded in a wallet-sized customer card provided to subscribers to the system, or may be initiated by the customer making a call to the server center announcing that the customer is on the way to pick up an order. If the customer is matched to an active order, at block 56, then a message is sent to the vendor responsible to fill the order of the customer's estimated time of arrival (ETA). The delivery location of the order may be a store, customer service desk, drive-through teller, pickup bay, etc.

The customer's ETA is referred to as the Delivery Window, as indicated at block 57. The Delivery Window is used by the system to offer advertisements for other products from the same vendor or products from other vendors along the way or in the vicinity of the pickup location, so that the customer has the option to make other purchases while in transit or in the vicinity of the pickup location. If the user does not have an order on the system to be picked up, the system can assign an open Delivery Window from the user's call-in within which ads can be sent to the user's device. Making a number of purchases while in transit maximizes the utility of the customer's time spent to make a pickup. It also allows the same vendor to make other sales to the same customer, or nearby vendors to make related sales while the customer is in transit or in the vicinity of the pickup location. The server processing center can determine policies to enhance cross-selling and avoid conflicts between vendors. Vendors that make related sales may pay a commission on the sale, or split a commission between the primary vendor and the server processing center. For example, a customer traveling by car to a mall to make a pickup of hardware supplies from a City Mill store located at one end of the mall may be sent ads for food specials from a nearby food store or discount on pizza from a nearby pizza store.

If the server 10 determines that the order is active for delivery and the customer for the order has been detected by a location-aware device in the vicinity, the server next estimates the time of arrival at the designated order pickup location. In this critical step of the process, server 10 can utilize a variety of known statistical and mapping functions to estimate the time a user will take to get from his known present location to the order pickup location. The algorithm may rely on statistical measures of average transit time taken, or apply standard deviation analytics and probability theory to estimate the time. The algorithm can utilize all available data to estimate the time of arrival, including present time of day, present weather, traffic updates, personalized data provided regarding preferences for mode of transportation, etc. The system can be adapted to dynamically “learn” how long a typical walker or driver takes to get from one point to another using real data. When a vehicle arrives at the pickup point outside on a predetermined variance, the system can estimate the ETA for all follow-on users using the same route or adjust it to either slower or faster times.

When server 10 has determined the ETA time for the customer to travel from starting Location A to destination Location B, it can formulate messages to be sent to vendors having stores located along the way to or near the designated order pickup point of the customer's impending arrival, and any vendor(s) interested in pitching products to the customer can upload via the server an advertisement to be called in to the customer's mobile phone number, or sent to their email address, or sent as a text or graphics message on their mobile device display. Alternatively, the server may have pre-stored advertisements for various vendors on its database, with authorization to transmit their ads to customers when determined to be appropriate.

These ads messages may be sent by a variety of methods to be received on a variety of user devices. In the preferred embodiment, the user device is a cellular telephone, which is text message capable. This is likely the cheapest and most flexible means by which to deliver the message, but those skilled in the art may imagine also that user device may include other mobile devices such as PDAs, or even simple telephone calls with automated voice messaging from server 10.

If the user does not have an active order on the system, the system will check its database to confirm whether the user's account has enabled “ads to user” in order to be considered to receive advertisements. The user may be assumed to be in transit to a potential vendor subscribed to the system in the vicinity of the user's location, or to a potential vendor or vendors indicated as preferred by the user on the system. If the user has the “ads to user” setting set to ‘yes’, the server can send ads to the user for suitable vendors based on location and/or preference settings in the user's account. Ads are sent to the user in the format corresponding to the mobile device for receiving messages that is designated on the system for the user.

The Response Time Window is the time pre-calculated by the vendor and is the vendor's best estimate of the time needed to prepare and execute the order. When responding to ads, the user will always be limited by the Response Window Time. If the user does not respond to an ad within the Response Window Time, the user is not guaranteed delivery in the usual time by the vendor. An affirmative response is required and the process will end for the user at the end of the Response Time Window unless initiated later by the user. The readings which do not result in a delivery are destroyed in order to protect user privacy.

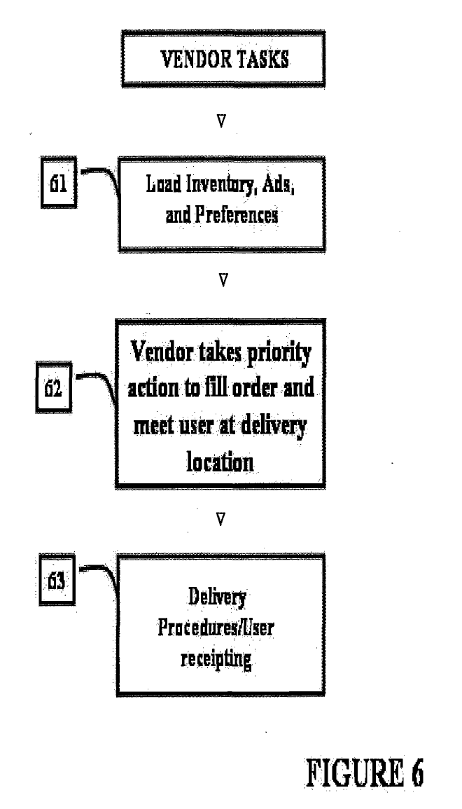

FIG. 6 shows a typical flow of vendor interactions with the system. Vendors can subscribe to the system and configure their accounts on the server database. Once registered on the network, the vendors can configure their account by loading preferences and ads, as indicated at block 61. This is the critical part where vendors configure the ads that will be sent to users when an ID and location reading is received. Preferences include means of communication, and time required to fill orders, and various metrics that the system uses. Vendors also upload their inventories of items to the system.

If the customer responds and places additional orders with the primary vendor or other vendors, the primary vendor takes priority to fill the active order and can coordinate delivery with other vendors at the delivery location, as indicated at block 62. The user may expect in most circumstances to have a minimal wait, with potentially the option to get all orders delivered together to their vehicle.

The actual delivery method to be utilized at the delivery location may be specified in delivery procedures and customer receipting requirements, as indicated at block 63. For example, such procedures may include delivery to vehicles, delivery on foot, delivery on the street, or in a building, etc. The necessary receipts are also delivered to the customer to enable return of items if necessary.

Vendors are motivated to utilize the system to provide “just-in-time” direct advertising because customers will enjoy the timesaving service provided and a vendor may differentiate its products and services from competitors. The system will also facilitate loyalty programs for repeat customers and offer new means of servicing and reaching these customers. Vendors will attain greater exposure when they are registered on the network. Additionally, vendors can save money by utilizing their delivery procedures more efficiently.

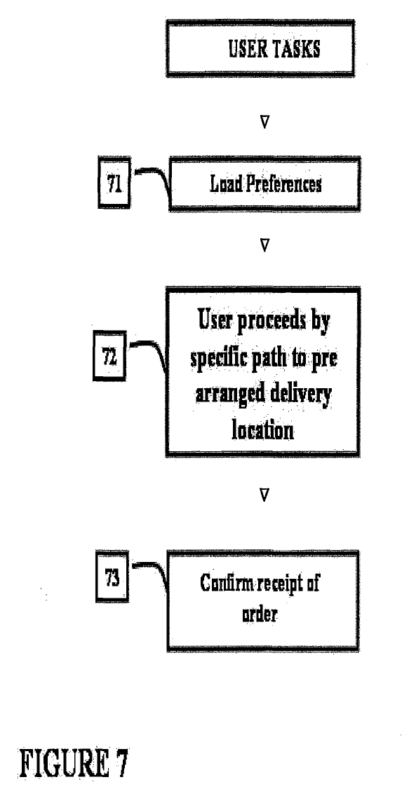

FIG. 7 shows a typical flow of user interactions with the system. Users are motivated to subscribe to the system because it is a more convenient and time saving means of shopping. Users are also attracted by the ease of use, and the relative low additional cost to utilize the service. Users register with the system by logging on to central processing server to receive a user ID and to configure their preferences, as indicated at block 71. These preferences become the basis of user interactions with the system when the user ID and location readings are received. In a system where RFID detection is used, the user is mailed an RFID tag, such as a wallet-sized card with an RFID chip embedded in it. When the user's ID is entered with an order, the system can then track orders placed by the user to receive its “just-in-time” advertising and delivery consolidation services as the user proceeds to the arranged deliver location, as indicated at block 72. If the user does not have a specific active order on the system, the user may elect to receive ads from the system's vendors in the vicinity of the user's location. User preferences also determine bundling items. Preferences also determine which means of communication the customer will use to receive confirmations and ads. Upon customer pickup at the delivery location, the system also tracks confirmation of the customer's receipt of the order, as indicated at block 73. The customer may utilize the receipt record to return items to the store.

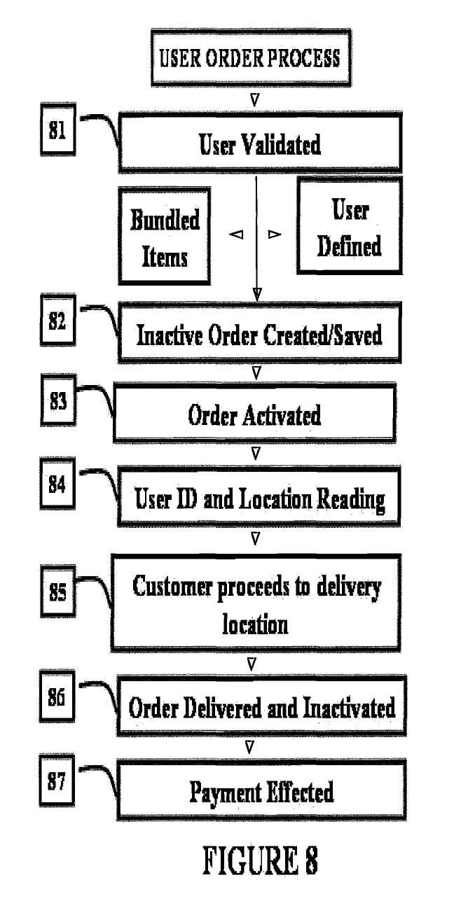

FIG. 8 illustrates the flow of the user's ordering process in the system. The user is validated, as indicated at block 81, upon subscribing to the system. User preferences for bundled items and other user-defined preferences are saved on the system. Bundling is a feature that allows the user to specify or the system to detect preferences for purchasing combinations of types of goods in the same time frame. This may be more fully developed by the system through the analysis of past purchasing activity. The system will apply preferences and purchase history analytics in creating a user's themed bundles.

Once validated, the user can create orders to be handled on the system (either on a participating vendor site or through the server's portal to the vendors). If the user is not taking delivery of an order at that time, the order is placed in “inactive” status and saved, as indicated at block 82. When the user is ready to take delivery of an order, the order is placed in “active” status, as indicated at block 83. An “active” order is one that the customer is ready to pick up, and awaits only a validated user ID and location reading, as indicated at block 84. When the customer has logged on, called in, or been detected as in the vicinity for pickup, an ETA is calculated as the customer proceeds to the delivery location, as indicated at block 85. During that “Delivery Window” of the ETA time, the system can send advertisements of products on sale, or on discount, or simply in convenient proximity, to the customer's phone or mobile device. A message may also be sent or forwarded to the user at this time to confirm that the order is ready for pickup. At the delivery location, the user receives the order and the order is inactivated and is saved as a record, as indicated at block 86. If any payment is required, it can be effected electronically from the user's mobile device, or through a billing account maintained through the server, as indicated at block 87. Payment would usually be processed at the time of the customer's placement of the order and before pickup of items, however.

Various system maintenance functions may also be performed by system administrators and agents to keep the system functioning at optimal levels. Examples of routine maintenance functions are: 1) update products, pricing, and coupons available at stores, 2) update store opening times, 3) update text message numbers for agents assigned to stores, 4) override server calculations of time expected to travel from various location to the store, 5) modify the algorithm used to compute expected times.

It is understood that many modifications and variations may be devised given the above description of the principles of the invention. It is intended that all such modifications and variations be considered as within the spirit and scope of this invention, as defined in the following claims.

1. A system for optimizing pickup of goods by a purchaser from one or more vendors comprising:
(a) a central processing server for tracking an order placed by a purchaser with a vendor for goods to be picked up at a delivery location in a service area, wherein said server maintains a database of information on vendors having stores at locations in the service area;
(b) a location-aware device operated by a purchaser for notifying the server of information as to the identity and location of the purchaser when the purchaser is ready to proceed in transit to a real or potential delivery location, whereupon said server calculates a delivery time window based on an estimated time-of-arrival of the purchaser to the real or potential delivery location; and
(c) a mobile messaging device associated with the purchaser for receiving one or more advertisement messages from the server sent during the delivery time window, wherein said server employs the purchaser's identity and location information and its database of vendor information to determine suitable advertisement messages of vendors to send to the purchaser's mobile messaging device while in transit to a real or potential delivery location.

2. A system according to claim 1, wherein the information of the location-aware device is generated by a mode selected from a group consisting of: a call sent from a purchaser's mobile phone; a message sent from a purchaser's mobile messaging device; a message sent online from a user's PC; a message sent online from a location-based public kiosk accessed by a purchaser; and detection of a purchaser's RFID tag by an RFID reader in the vicinity of the purchaser.

3. A system according to claim 1, wherein the purchaser's messaging device is one selected from a group consisting of: a purchaser's mobile phone; a purchaser's mobile messaging device; and a location-based public kiosk accessed by a purchaser.

4. A system according to claim 1, wherein the advertising messages sent by the server to the purchaser's messaging device correspond to vendors having stores located along a path of transit from the purchaser-notified location to a real or potential delivery location.

5. A system according to claim 4, wherein the advertising messages are for sales, discounts, or other products of vendors having stores located along the way to or in the vicinity of a real or potential delivery location.

6. A system according to claim 1, wherein said server is operated to send advertisement messages to a purchaser's messaging device upon receiving information from a location-aware device notifying the server as to the identity and location of the purchaser even when the purchaser does not have an order to pick up at a specific delivery location.

7. A system according to claim 1, wherein said database of the server is used to store advertisement messages of vendors subscribed to the system for sending to the purchaser's messaging device.

8. A system according to claim 1, wherein the vendor information in said database of the server is used to determine which vendors are suitable for sending advertisement messages to the purchaser.

9. A system according to claim 8, wherein said server sends messages to notify the vendors determined as suitable that they may send advertisement messages to the purchaser's messaging device via said server for forwarding to the purchaser's messaging device.

10. A system according to claim 9, wherein upon a purchaser placing an order to said server in response to an advertisement message of a vendor sent to the purchaser, said server makes arrangements for consolidating delivery of the order with any existing order of the purchaser being monitored by the system in the vicinity of the purchaser's location.

11. A method for optimizing pickup of goods by a purchaser from one or more vendors comprising the steps of:
(a) tracking through a central processing server an order placed by a purchaser with a vendor for goods to be picked up at a delivery location in a service area, and maintaining with the server a database of information on vendors having stores at locations in the service area;
(b) receiving at the central processing server information as to the identity and location of the purchaser when the purchaser is ready to proceed in transit to a real or potential delivery location, whereupon said server calculates a delivery time window based on an estimated time-of-arrival of the purchaser to the real or potential delivery location; and
(c) sending one or more advertisement messages from the server to a messaging device operated by the purchaser during the delivery time window, based upon the server's using the purchaser's identity and location information and its database of vendor information to determine suitable advertisements that may be sent to the purchaser's messaging device.

12. A method according to claim 11, wherein the information as to the identity and location of the purchaser is generated by a mode selected from a group consisting of: a call sent from a purchaser's mobile phone; a message sent from a purchaser's mobile messaging device; a message sent online from a user's PC; a message sent online from a location-based public kiosk accessed by a purchaser; and detection of a purchaser's RFID tag by an RFID reader in the vicinity of the purchaser.

13. A method according to claim 11, wherein the purchaser's messaging device is one selected from a group consisting of: a purchaser's mobile phone; a purchaser's mobile messaging device; and a location-based public kiosk accessed by a purchaser.

14. A method according to claim 11, wherein the advertising messages sent by the server to the purchaser's messaging device correspond to vendors having stores located along a path of transit from the purchaser-notified location to a real or potential delivery location.

15. A method according to claim 14, wherein the advertising messages are for sales, discounts, or other products of vendors having stores located along the way to or in the vicinity of a real or potential delivery location.

16. A method according to claim 11, wherein said server is operated to send advertisement messages to a purchaser's messaging device upon receiving information from a location-aware device notifying the server as to the identity and location of the purchaser even when the purchaser does not have an order to pick up at a specific delivery location.

17. A method according to claim 11, wherein said database of the server is used to store advertisement messages of vendors subscribed to the system for sending to the purchaser's messaging device.

18. A method according to claim 11, wherein the vendor information in said database of the server is used to determine which vendors are suitable for sending advertisement messages to the purchaser.

19. A method according to claim 18, wherein said server sends messages to notify the vendors determined as suitable that they may send advertisement messages to the purchaser's messaging device via said server for forwarding to the purchaser's messaging device.

20. A method according to claim 19, wherein upon a purchaser placing an order to said server in response to an advertisement message of a vendor sent to the purchaser, said server makes arrangements for consolidating delivery of the order with any existing order of the purchaser being monitored by the system in the vicinity of the purchaser's location.
